(19) United States
(12) Patent Application Publication
(10) Pub. No.: US 2006/0119761 A1
(43) Pub. Date: Jun. 8, 2006

(54) Display and mobile device

(76) Inventor: Tatsumi Okuda, Motosu-shi (JP)

Correspondence Address: MCDERMOTT WILL & EMERY LLP, 600 13TH STREET, N.W., WASHINGTON, DC, 20005-3096, US

(21) Appl. No.: 11/289,632

(22) Filed: Nov. 30, 2005

(30) Foreign Application Priority Data
Nov. 30, 2004 (JP) JP2004-345313

(51) Int. Cl. G02F 1/1333

(52) U.S. Cl. 349/58

(57) ABSTRACT

A display is provided that can prevent uplift of a flexible printed circuit board due to flexure deformation of the flexible printed circuit board. The display includes: a display panel; a frame that houses the display panel; a backlight source that is disposed on the backside of the display panel; and a first flexible printed circuit board for backlight that is electrically connected to the backlight source, and extends from the inside of the frame to the outside of the frame. The frame has an uplift preventing member that prevents uplift of the first flexible printed circuit board.

### BACKGROUND OF THE INVENTION

1. Field of the Invention

The present invention relates to a display and a mobile device, and more particularly, to a display that has a flexible printed circuit board, and a mobile device that includes the display.

### CROSS-REFERENCE TO RELATED APPLICATIONS

The priority application No. JP2004-345313 upon which this patent application is based is hereby incorporated by reference.

2. Description of the Background Art

Conventionally, there have been displays such as liquid crystal display units having flexible printed circuit boards. An example of such a display is disclosed in Japanese Patent Publication No. 3322629. More specifically, Japanese Patent Publication No. 3322629 discloses a liquid crystal display unit that has display panel to which a flexible printed circuit board housed by a metal upper frame and a metal lower frame is connected, and a backlight source that emits light onto the display panel.

Conventionally, LCD (Liquid Crystal Display) units having small-sized display panels to be used for mobile phone handsets have been known. FIG. 26 is a perspective view of a conventional LCD unit. FIG. 27 is an exploded view of the conventional LCD unit shown in FIG. 26. FIG. 28 is a cross-sectional view of the resin frame of the conventional LCD unit shown in FIG. 26. FIGS. 29 through 31 illustrate the structure of the conventional LCD unit. Referring to FIGS. 26 through 31, the structure of the conventional LCD unit is described in detail.

As shown in FIGS. 26 and 27, the conventional LCD unit 120 includes an upper frame 101 and a lower frame 102 that are made of metal, a reflective sheet 103, a resin frame 104, a light guide plate 105, lens sheets 106 and 107, a backlight flexible printed circuit board (backlight FPC board) 108, light emitting diodes (LEDs) 109, a diffusion sheet 110, a display panel 111, a driver IC 112, a panel flexible printed circuit board (panel FPC board) 113, and electronic components 114 and 115.

As shown in FIG. 27, the upper frame 101 made of metal has an insertion hole 101a, an opening 101b formed in conformity with the display region of the display panel 111, and a notch portion 101c at which the backlight FPC board 108 and the panel FPC board 113 are disposed. The lower frame 102 made of metal has a protruding portion 102a to be engaged with the insertion hole 110a of the upper frame 101, and a notch portion 102b that is formed at the location corresponding to the notch portion 101c of the upper frame 101 and accommodates the backlight FPC board 108 and the panel FPC board 113. The reflective sheet 103 that reflects light is disposed on the lower frame 102. As shown in FIG. 30, the resin frame 104 is disposed on the reflective sheet 103. As shown in FIG. 28, the resin frame 104 has an opening 104a and a FPC inserting portion 104b to which the backlight FPC board 108 and the panel FPC board 113 are inserted. As shown in FIG. 27, the light guide plate 105 that introduces light onto the entire panel, and the lens sheets 106 and 107 that concentrate light are disposed on the resin frame 104 in this order from the bottom. The backlight FPC board 108 is attached onto the lens sheet 107. The LEDs 109 for emitting light to the light guide plate 105 are attached to the backlight FPC board 108. The light emitted from the LEDs 109 diffuses inside the light guide plate 105, and travels to the lens sheets 106 and 107 that are located above the light guide plate 105. The light is concentrated by the lens sheets 106 and 107, and then travels to the display panel 111 via the diffusion sheet 110 that is located above the lens sheets 106 and 107.

The backlight FPC board 108 can be deformed through flexure. The backlight FPC board 108 has a LED attaching portion 108a, an external connecting portion 108b extending from the inside of the resin frame 104 to the outside of the resin frame 104, and a connector inserting portion 108c. The connector inserting portion 108c of the backlight FPC board 108 is mounted to a connector portion 113a of the panel FPC board 113.

As shown in FIG. 30, the external connecting portion 108b of the backlight FPC board 108 is designed to be longer than the linear distance between the LED attaching portion 108a and the connector inserting portion 108c, so that the connector inserting portion 108c can be easily mounted in the connector portion 113a. Accordingly, with the connector inserting portion 108c being mounted in the connector portion 113a, the external connecting portion 108b of the backlight FPC board 108 is deformed and uplifted.

As shown in FIG. 29, the driver IC 112 and the panel FPC board 113 are attached to the display panel 111. As shown in FIG. 26, the panel FPC board 113 is designed to extend outward from the opening that is formed by the notch portion 101c of the upper frame 101 and the notch portion 102b of the lower frame 102. The panel FPC board 113 also has the connector portion 113a to which the connector inserting portion 108c of the backlight FPC board 108 is inserted as described above. The panel FPC board 113 further has an electronic component attaching portion 113b to which the electronic component 114 is mounted. The panel FPC board 113 also has a connector inserting portion 113c to be inserted to a connector (not shown). Further, the panel FPC board 113 has an electronic component attaching portion 113d to which the electronic component 115 is mounted. Also, a slit 113e is formed between the connector inserting portion 113c and the electronic component attaching portion 113d.

In the conventional LCD unit illustrated in FIGS. 26 through 31, the force F2 generated by the flexure deformation of the external connecting portion 108b of the backlight FPC board 108 shown in FIG. 30 causes the problem of uplifting the backlight FPC board 108 at the portion to which the LEDs 109 are to be attached, as shown in FIG. 31. When this problem is caused, the light emitted from the LEDs 109 leaks out of the resin frame 104, and the light to illuminate the display panel 111 becomes insufficient. As a result, a decrease in the luminance of the display panel 111 is caused. Furthermore, when the portion of the backlight FPC board 108 to which the LEDs 109 are to be attached is uplifted, engagement of the upper frame 101 with the lower frame 102 becomes difficult after the connector inserting portion 108c of the backlight FPC board 108 is inserted to the connector portion 113a of the panel FPC board 113 at the time of assembling. As a result, the assembling workability becomes lower.

Also, in the above described structure disclosed in Japanese Patent Publication No. 3322629, it is considered that a member attached to the flexible printed circuit board is uplifted by the force generated by flexure deformation of the flexible printed circuit board, as in the conventional LCD unit illustrated in FIGS. 26 through 30. In such a case, the light emitted from the backlight source leaks out of the frame, and the light to illuminate the display panel becomes insufficient. As a result, the problem of a decrease in the luminance of the display panel is caused.

### SUMMARY OF THE INVENTION

A general object of the present invention is to eliminate the above disadvantages. A more specific object of the present invention is to provide a display and a mobile device that can prevent uplift of the flexible printed circuit board caused by flexure deformation of the flexible printed circuit board.

So as to achieve the above objects, a display in accordance with a first aspect of the present invention includes: a display panel; a frame that houses the display panel; a backlight source that is disposed on the backside of the display panel; and a first flexible printed circuit board for emitting backlight that is electrically connected to the backlight source, and extends from the inside of the frame to the outside of the frame, with the frame having an uplift preventing member that prevents uplift of the first flexible printed circuit board.

As described above, the display in accordance with the first aspect of the present invention has an uplift preventing member for preventing uplift of the first flexible printed circuit board for backlight. Accordingly, the first flexible printed circuit board for backlight and the backlight source can be prevented from being uplifted due to flexure deformation of the first flexible printed circuit board for backlight. Accordingly, the light emitted from the backlight source can be prevented from leaking out of the frame. Thus, a decrease in the luminance of the display panel can be avoided. Furthermore, uplift of the first flexible printed circuit board for backlight and the backlight source can be prevented. Accordingly, the upper frame can be surely engaged with the lower frame at the time of assembling. Thus, the assembling workability can be increased.

A mobile device in accordance with a second aspect of the present invention includes the above described display in accordance with the first aspect of the present invention. With this structure, a mobile device equipped with a display that can prevent uplift of the first flexible printed circuit board for backlight can be obtained.

### BRIEF DESCRIPTION OF THE DRAWINGS

FIG. 1 is a perspective view of a LCD unit having a flexible printed circuit board in accordance with an embodiment of the present invention;

FIG. 2 is a side view of the LCD unit in accordance with the embodiment shown in FIG. 1, where the LCD unit is mounted to a printed circuit board of a mobile phone handset;

FIG. 3 is an exploded perspective view of the LCD unit in accordance with the embodiment shown in FIG. 1;

FIG. 4 is a perspective view illustrating the resin frame and the display panel of the LCD unit in accordance with the embodiment shown in FIG. 1;

FIG. 5 is a cross-sectional view illustrating the resin frame and the backlight FPC board of the LCD unit in accordance with the embodiment shown in FIG. 1;

FIG. 6 is a perspective view illustrating the display panel of the LCD unit in accordance with the embodiment shown in FIG. 1;

FIG. 7 is a cross-sectional view illustrating the connector portion of the backlight FPC board of the LCD unit in accordance with the embodiment shown in FIG. 1;

FIG. 8 is a perspective view illustrating the light guide plate, the light emitting diode (LED), and the backlight FPC board of the LCD unit in accordance with the embodiment shown in FIG. 1;

FIG. 9 is a side view illustrating the light guide plate, the light emitting diode (LED), and the backlight FPC board of the LCD unit in accordance with the embodiment shown in FIG. 1;

FIG. 10 is a perspective view illustrating the light guide plate, the light emitting diode (LED), and the backlight FPC board of the LCD unit in accordance with the embodiment shown in FIG. 1;

FIG. 11 is a perspective view illustrating the resin frame of the LCD unit in accordance with the embodiment shown in FIG. 1;

FIG. 12 is a front view illustrating the resin frame of the LCD unit in accordance with the embodiment shown in FIG. 1;

FIG. 13 is a perspective view illustrating the attachment structure of the LCD unit in accordance with the embodiment shown in FIG. 1;

FIG. 14 is a perspective view illustrating the attachment structure of the LCD unit in accordance with the embodiment shown in FIG. 1;

FIG. 15 is a perspective view illustrating the attachment structure of the LCD unit in accordance with the embodiment shown in FIG. 1;

FIG. 16 is a cross-sectional view illustrating the attachment structure of the LCD unit in accordance with the embodiment shown in FIG. 1;

FIG. 17 is a cross-sectional view illustrating the attachment structure of the LCD unit in accordance with the embodiment shown in FIG. 1;

FIG. 18 is a perspective view of a LCD unit in accordance with a first modification of the embodiment of the present invention;

FIG. 19 is a cross-sectional view of the LCD unit in accordance with the modification shown in FIG. 18;

FIG. 20 is a perspective view of a LCD unit in accordance with a second modification of the embodiment of the present invention, where the LCD unit is mounted to the printed circuit board of a mobile phone handset;

FIG. 21 is a side view of the LCD unit in accordance with the second modification shown in FIG. 20, where the LCD unit is mounted to the printed circuit board of a mobile phone handset;

FIG. 22 is a perspective view of a LCD unit in accordance with a third modification of the embodiment of the present invention, where the LCD unit is mounted to the printed circuit board of a mobile phone handset;

FIG. 23 is a side view of the LCD unit in accordance with the third modification shown in FIG. 22, where the LCD unit is mounted to the printed circuit board of a mobile phone handset;

FIG. 24 is a perspective view of a LCD unit in accordance with a fourth modification of the embodiment of the present invention, where the LCD unit is mounted to the printed circuit board of a mobile phone handset;

FIG. 25 is a side view of the LCD unit in accordance with the fourth modification shown in FIG. 24, where the LCD unit is mounted to the printed circuit board of a mobile phone handset;

FIG. 26 is a perspective view of a conventional LCD unit;

FIG. 27 is an exploded perspective view of the conventional LCD unit shown in FIG. 26;

FIG. 28 is a perspective view illustrating the resin frame of the conventional LCD unit shown in FIG. 26;

FIG. 29 is a perspective view illustrating the resin frame and the display panel of the conventional LCD unit shown in FIG. 26;

FIG. 30 is a cross-sectional view illustrating the attachment structure of the flexible printed circuit board and the connector portion of the conventional LCD unit shown in FIG. 26; and

FIG. 31 is a cross-sectional view illustrating the attachment structure of the flexible printed circuit board and the connector portion of the conventional LCD unit shown in FIG. 26.

### DESCRIPTION OF THE PREFERRED EMBODIMENTS

The following is a description of embodiments of the present invention, with reference to the accompanying drawings.

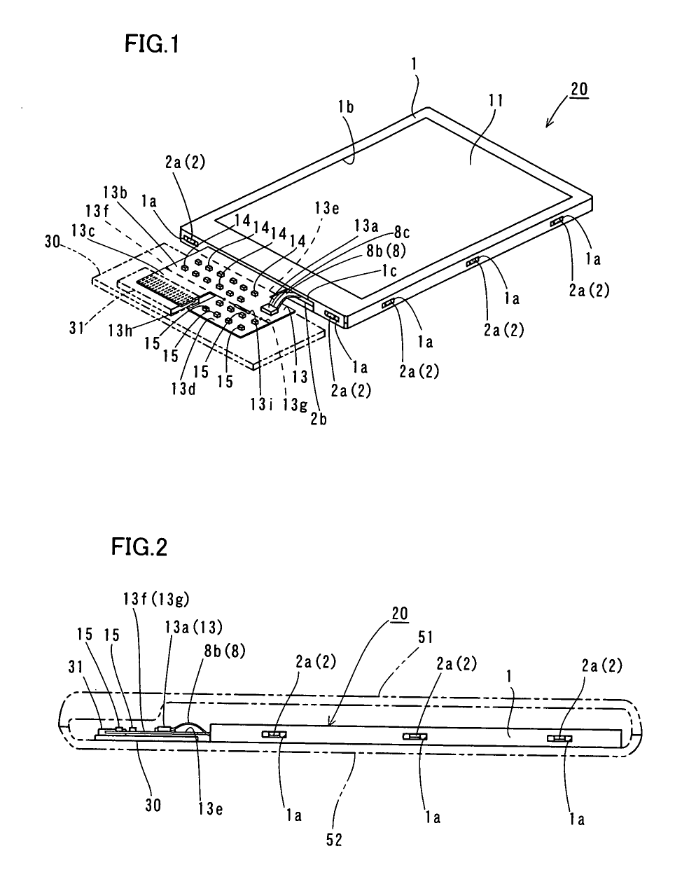

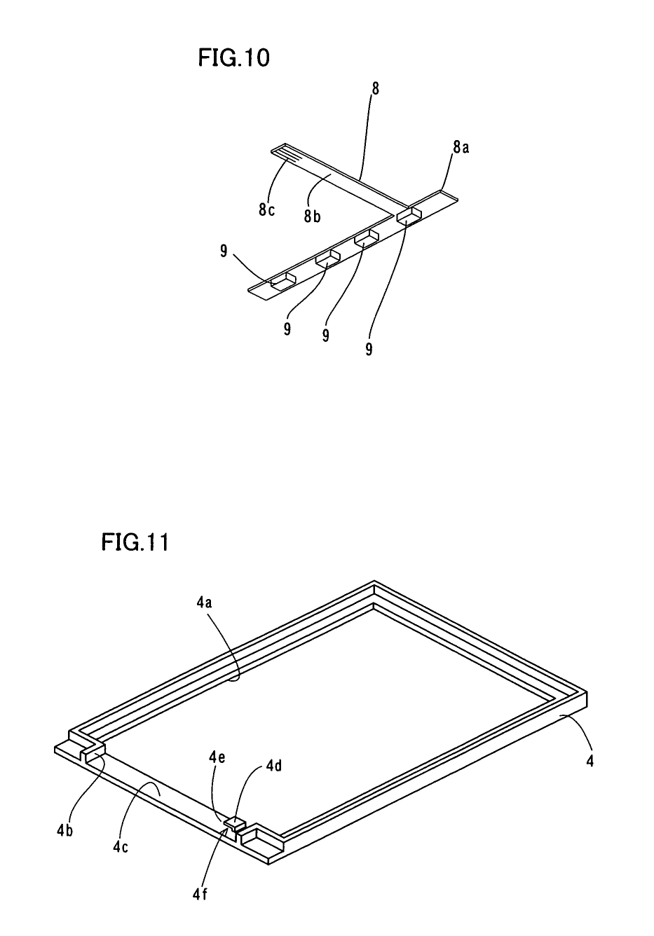

Referring to FIGS. 1 through 17, a LCD unit 20 in accordance with an embodiment of the present invention is described. In this embodiment, the LCD unit 20 is described as an example of the “display” in the claims.

As shown in FIGS. 1 through 3, the LCD unit 20 in accordance with this embodiment includes an upper frame 1 and a lower frame 2 that are made of metal, a reflective sheet 3, a resin frame 4, a light guide plate 5, lens sheets 6 and 7, a backlight flexible printed circuit board (backlight FPC board) 8, light emitting diodes (LEDs) 9, a diffusion sheet 10, a display panel 11 that are formed with glass substrates including liquid crystal and a thin-film transistor, a driver IC 12, a panel flexible printed circuit board (panel FPC board) 13, and electronic components 14 and 15. As shown in FIG. 2, the LCD unit 20 is housed in an upper chassis 51 and a lower chassis 52 of a mobile phone handset, and the connector inserting portion 13c (see FIG. 1) of the panel FPC board 13 of the LCD unit 20 is connected to a connector portion 31 of the printed circuit board 30 of the mobile phone handset. The resin frame 4 is an example of the “frame” in the claims. The backlight FPC board 8 is an example of the “first flexible printed circuit board” in the claims, and the panel FPC board 13 is an example of the “second flexible printed circuit board” in the claims. The LEDs 9 are an example of the “backlight source” in the claims. The electronic component 14 is an example of the “first electronic component” in the claims, and the electronic component 15 is an example of the “second electronic component” in the claims.

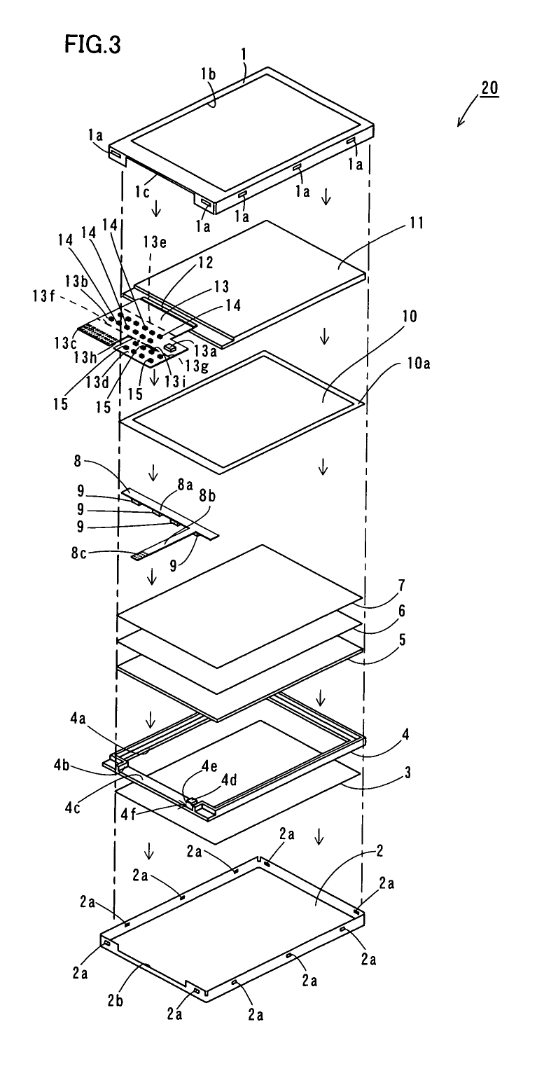

As shown in FIG. 3, the upper frame 1 made of metal has an insertion hole 1a, an opening 1b, and a notch portion 1c at which the backlight FPC board 8 and the panel FPC board 13 are disposed. The lower frame 2 made of metal has a protruding portion 2a to be engaged with the insertion hole 1a of the upper frame 1, and a notch portion 2b that is formed at the location corresponding to the notch portion 1c of the upper frame 1 and accommodates the backlight FPC board 8 and the panel FPC board 13. The reflective sheet 3 to reflect light is disposed on the lower frame 2. The reflective sheet 3 is also attached to the bottom face of the resin frame 4, and upwardly reflects downward light. The light guide plate 5 that introduces light to the entire panel, and the lens sheets 6 and 7 that concentrate light are disposed on the resin frame 4 are arranged on the upper side of the resin frame 4 in this order from the bottom. The backlight FPC board 8 is mounted onto the lens sheet 7. The four LEDs 9 that emit light onto the light guide plate 5 are mounted to the backlight FPC board 8. The light emitted from the LEDs 9 to the light guide plate 5 diffuses inside the light guide plate 5, and travels to the lens sheets 6 and 7 that are located above the light guide plate 5. The light is concentrated by the lens sheets 6 and 7, and is then emitted to the display panel 11 via the diffusion sheet 10 located above the lens sheets 6 and 7.

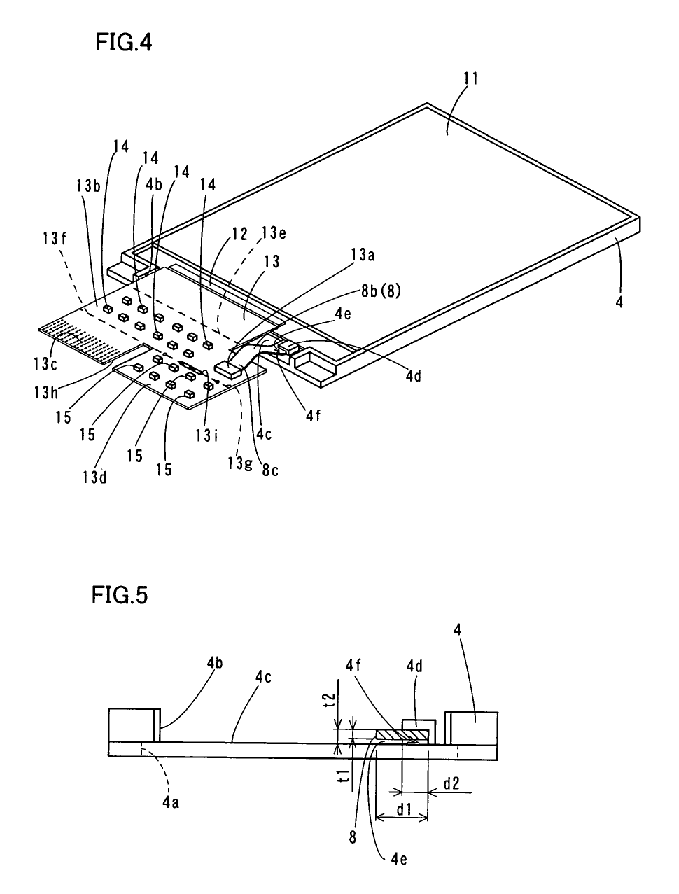

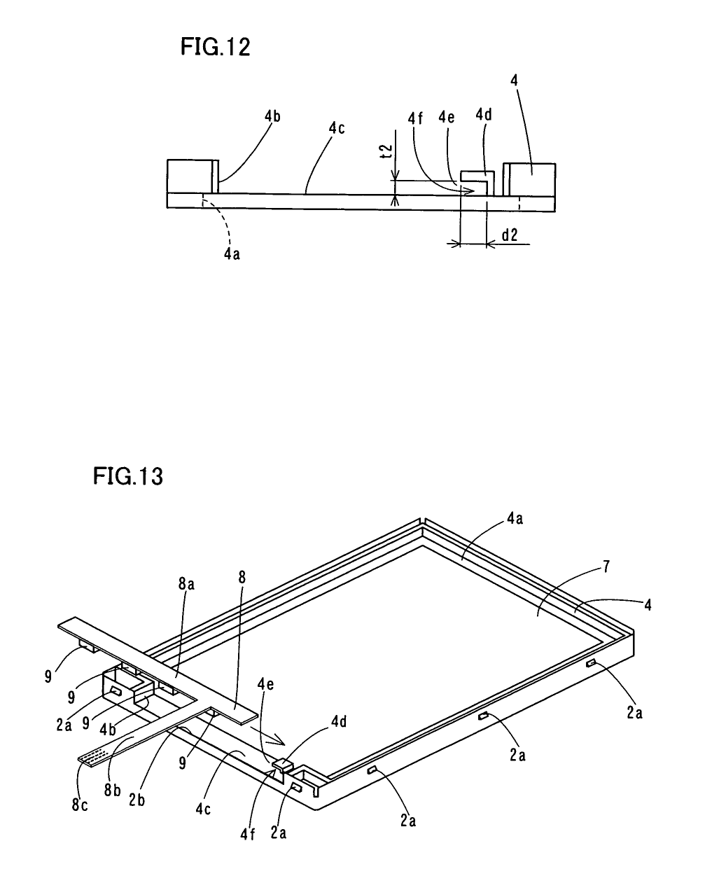

In this embodiment, the resin frame 4 has an opening 4a and a FPC inserting portion 4b to which the backlight FPC board 8 and the panel FPC board 13 are inserted, as shown in FIGS. 3 and 4. As shown in FIGS. 11 and 12, a hook-like portion 4d is integrally formed with the upper face 4c of the FPC inserting portion 4b of the resin frame 4. The hook-like portion 4d is an example of the “uplift preventing portion” in the claims. The hook-like portion 4d and the upper face 4c of the FPC inserting portion 4b form an engaging space 4f having an inserting portion 4e. As shown in FIG. 5, the hook-like portion 4d is engaged with the upper face of the backlight FPC board 8, so as to restrict the height of the backlight FPC board 8 and prevent uplift of the backlight FPC board 8. As shown in FIGS. 4 and 5, the backlight FPC board 8 is disposed in the engaging space 4f defined by the hook-like portion 4d and the upper face 4c of the resin frame 4. The vertical length t2 of the engaging space 4f may be 1.2 to 2.0 times as large as the thickness t1 of the backlight FPC board 8, for example. As the vertical length of the engaging space 4f of the hook-like portion 4d is larger than the thickness of the backlight FPC board 8, a predetermined space in the vertical direction is left between the engaging space 4f and the backlight FPC board 8. Accordingly, the backlight FPC board 8 can be easily disposed in the engaging space 4f formed by the upper face 4c of the resin frame 4 and the hook-like portion 4d. The horizontal length d2 of the engaging space 4f is ⅓ to ⅔ of the width d1 of the backlight FPC board 8. As the horizontal length d2 of the engaging space 4f of the hook-like portion 4d is smaller than the width of the backlight FPC board 8, the backlight FPC board 8 can be easily disposed in the engaging space 4f formed by the upper face 4c of the resin frame 4 and the hook-like portion 4d. The inserting portion 4e of the engaging space 4f opens in the direction that is perpendicular to the direction extending from the inside of the resin frame 4 to the outside of the resin frame 4. The engaging space 4f is located in the vicinity of an outer edge of the resin frame 4.

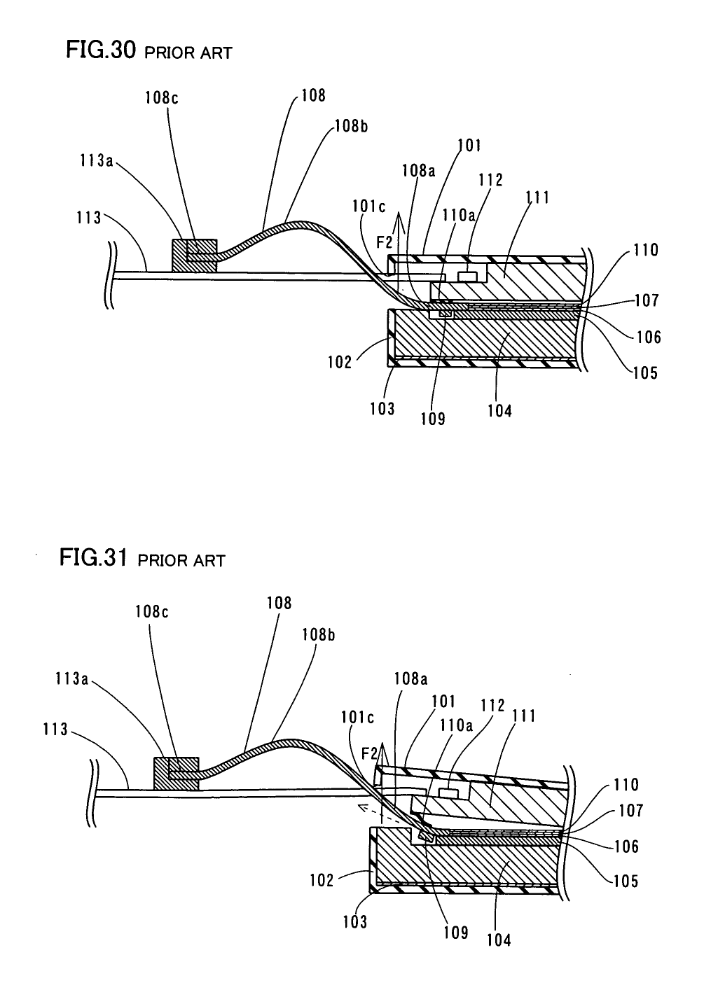

In this embodiment, the backlight FPC board 8 has flexibility, and extends from the inside to the outside of the resin frame 4, as shown in FIG. 4. The backlight FPC board 8 is also electrically connected to the LEDs 9. As shown in FIG. 3, the backlight FPC board 8 has a LED attaching portion 8a, an external connecting portion 8b that extends from the inside of the resin frame 4 to the outside of the resin frame 4, and a connector inserting portion 8c. The four LEDs 9 are attached at predetermined intervals to the LED attaching portion 8a of the backlight FPC board 8. As shown in FIG. 17, the connector inserting portion 8c of the backlight FPC board 8 is mounted in the connector portion 13a of the panel FPC board 13. The external connecting portion 8b of the backlight FPC board 8 is designed to be greater than the linear distance between the LED attaching portion 8a and the connector inserting portion 8c, so that the connector inserting portion 8c can be easily disposed inside the connector portion 13a. Therefore, with the connector inserting portion 8c being mounted in the connector portion 13a, the external connecting portion 8b of the backlight FPC board 8 is deformed and is uplifted. To counter this problem, the backlight FPC board 8 is held at the portions on which force F2 acts. The force F2 is caused in the vicinity of the upper frame 101 and the lower frame 102 shown in FIGS. 30 and 31. Thus, uplift of the external connecting portion 8b is prevented in this embodiment.

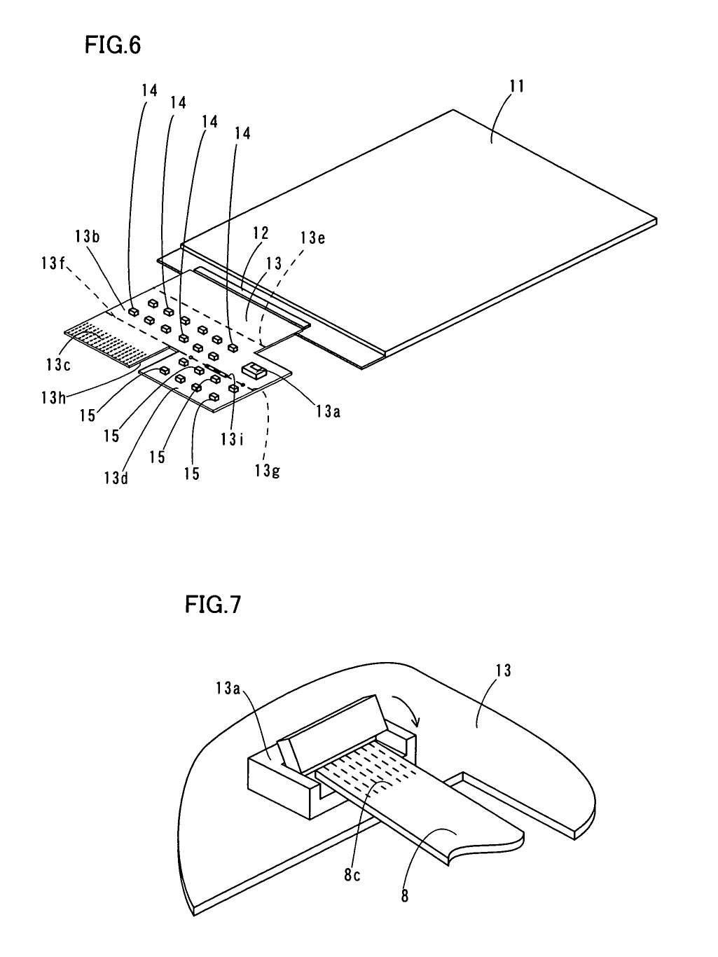

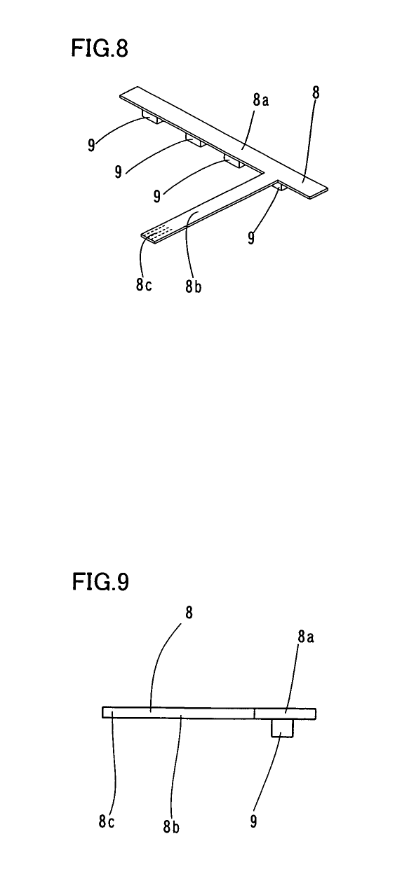

As shown in FIGS. 8 through 10, the four LEDs 9 are arranged to face a side face of the light guide plate 5, and function to emit light to the light guide plate 5. As shown in FIG. 3, the diffusion sheet 10 is disposed on the backlight FPC board 8. The diffusion sheet 10 has an adhesive layer 10a for bonding the diffusion sheet 10 to the display panel 11. The display panel 11 is disposed on the diffusion sheet 10. As shown in FIGS. 3 and 6, the driver IC 12 and the panel FPC board 13 are attached onto the surface of the display panel 11. As shown in FIG. 1, the panel FPC board 13 extends outward via the opening that is formed by the notch portion 1c of the upper frame 1 and the notch portion 2b of the lower frame 2.

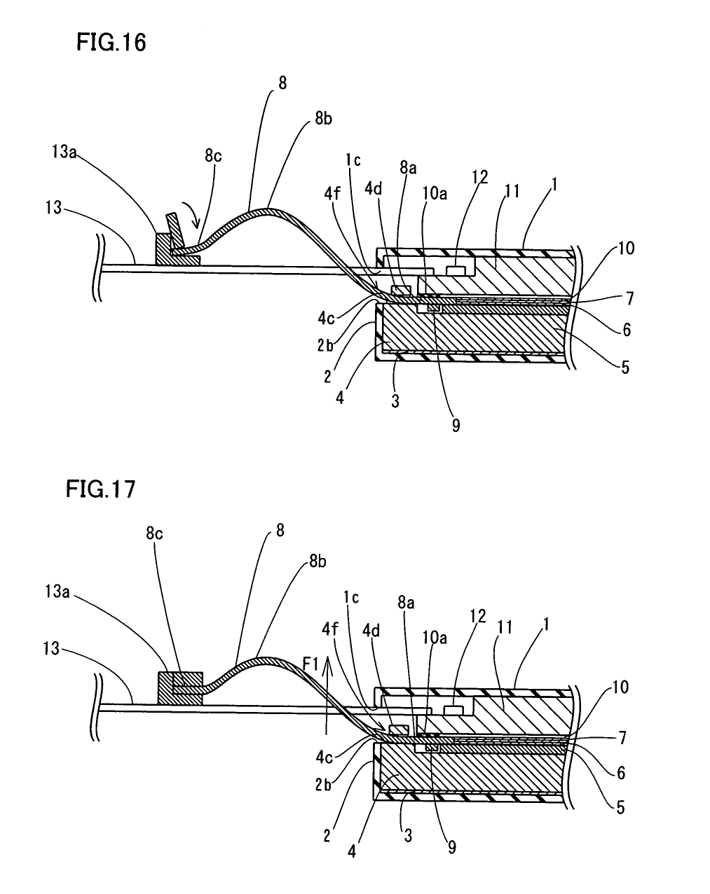

As shown in FIG. 4, the panel FPC board 13 is engaged with the FPC inserting portion 4b of the resin frame 4, and extends outward. As shown in FIG. 6, the panel FPC board 13 has the connector portion 13a. As shown in FIGS. 7 and 16, the connector inserting portion 8c of the backlight FPC board 8 is sandwiched by the connector portion 13a, so that the backlight FPC board 8 is electrically connected to the panel FPC board 13. As shown in FIG. 6, the panel FPC board 13 also has an electronic component attaching portion 13b to which the electronic component 14 is to be attached, a connector inserting portion 13c, and an electronic component attaching portion 13d to which the electronic component 15 is to be attached. Further, a slit 13h is formed between the connector inserting portion 13c and the electronic component attaching portion 13d of the panel FPC board 13, so that the connector inserting portion 13c and the electronic component attaching portion 13d can be bent independently of each other. The electronic component attaching portion 13b is an example of the “first electronic attaching portion” in the claims, and the electronic component attaching portion 13d is an example of the “second electronic attaching portion” in the claims.

In this embodiment, the panel FPC board 13 further includes a bending portion 13e that is formed on the side of the display panel 11, a bending portion 13f that is formed between the electronic component attaching portion 13b and the connector inserting portion 13c, and a bending portion 13g that is formed between the electronic component attaching portion 13b and the electronic component attaching portion 13d. A bending hole 13i is formed in the bending portion 13g, so as to facilitate the bending of the bending portion 13g. The bending portion 13e is an example of the “first bending portion” in the claims, the bending portion 13f is an example of the “second bending portion” in the claims, and the bending portion 13g is an example of the “third bending portion” in the claims. The bending portions 13e, 13f, and 13g may be folded either forward or backward.

Next, the procedures for assembling the LCD unit in accordance with this embodiment are described in conjunction with FIGS. 1, 3, and 13 through 17.

As shown in FIG. 3, the reflective sheet 3 is disposed below the bottom face of the lower frame 2 made of metal, and the resin frame 4 is disposed on the reflective sheet 3. After the light guide plate 5 and the lens sheets 6 and 7 are set in the resin frame 4, the backlight FPC board 8 on which the LEDs 9 are mounted is set in the resin frame 4.

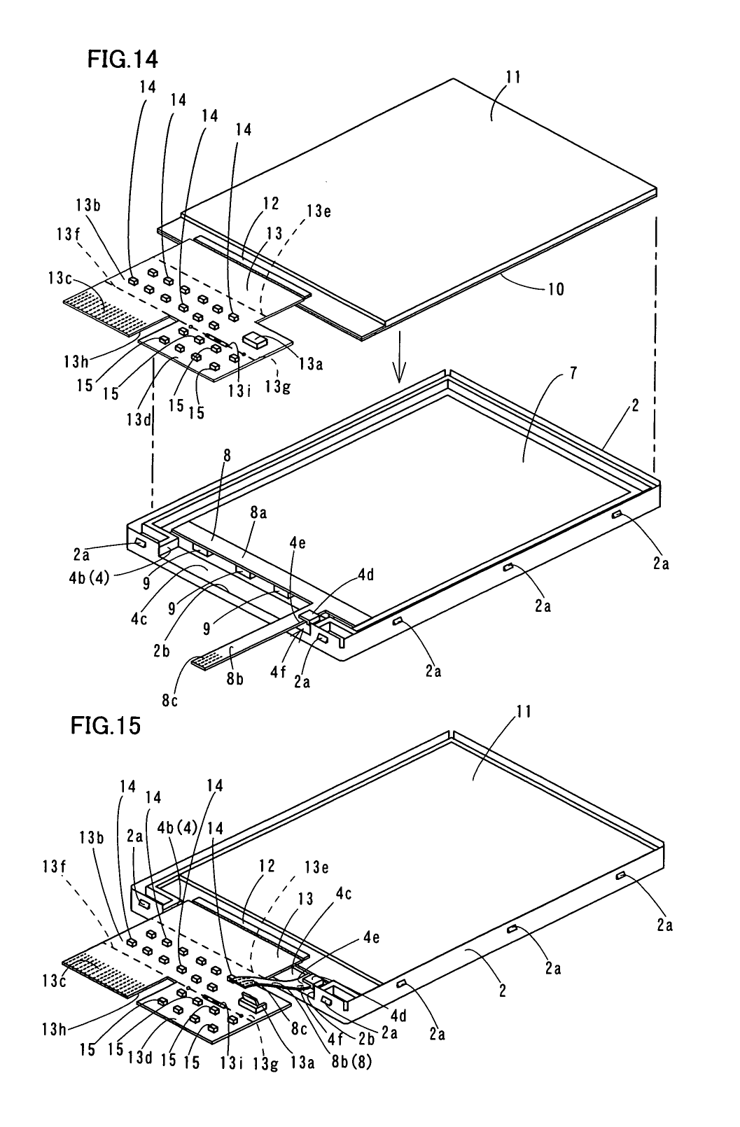

In this embodiment, the external connecting portion 8b of the backlight FPC board 8 is then inserted to the inserting portion 4e of the engaging space 4f of the resin frame 4 from the direction that is perpendicular to the direction extending from the inside of the resin frame 4 to the outside of the resin frame 4, as shown in FIG. 13. Accordingly, the hook-like portion 4d of the resin frame 4 is engaged with the upper face of the backlight FPC board 8, so that uplift of the backlight FPC board 8 is prevented. At the time of the insertion of the backlight FPC board 8, the top end of the connector inserting portion 8c of the backlight FPC board 8 and the likes can be prevented from coming into contact with the lens sheet 7 and the likes in the resin frame 4. Accordingly, damage to the lens sheet 7 and the likes disposed in the resin frame 4 can be prevented. As shown in FIG. 14, the display panel 11 is then set in the resin frame 4 from the above. The driver IC 12 and the panel FPC board 13 are attached onto the surface of the display panel 11, and the diffusion sheet 10 is bonded to the bottom surface of the display panel 11. As a result, the structure shown in FIG. 15 is formed. The connector inserting portion 8c of the backlight FPC board 8 is then inserted to the connector portion 13a of the panel FPC board 13, thereby forming the structure shown in FIG. 16. The insertion hole 1a (see FIG. 3) of the upper frame 1 is then engaged with the protruding portion 2a (see FIG. 3) of the lower frame 2. Thus, the structure shown in FIGS. 1 and 17 is formed, and the assembling of the LCD unit 20 is completed.

As described above, the resin frame 4 has the hook-like portion 4d for preventing uplift of the backlight FPC board 8 in this embodiment. Accordingly, the backlight FPC board 8 and the LEDs 9 can be prevented from being lifted upward due to the force F1 (see FIG. 17) generated by flexure deformation of the backlight FPC board 8. Thus, the light emitted from the LEDs 9 can be prevented from leaking out of the resin frame 4, and a decrease in the luminance of the display panel 11 can be avoided. Also, as the backlight FPC board 8 and the LEDs 9 are prevented from being lifted upward, the upper frame 1 can be surely engaged with the lower frame 2 at the time of assembling. Thus, the assembling workability can be increased.

Further, the hook-like portion 4d of the resin frame 4 is integrally formed with the resin frame 4 in this embodiment. Accordingly, the number of components does not increase, even with the hook-like portion 4d.

It should be understood that the above described embodiment is merely an example in all aspects and does not limit the scope of the present invention. The scope of the present invention is shown by the claims, instead of the above described embodiment. Any modification can be made to the above described embodiment within the spirit and scope of the present invention.

For example, although the present invention is applied to a LCD unit as a display in the above embodiment, it may be applied to any display other than a LCD unit.

Also, the LCD unit is mounted in a mobile phone handset in the above described embodiment, but the present invention is not limited to that. It is possible to mount the LCD unit for the mobile device in a mobile information terminal such as a PDA (Personal Digital Assistant), a mobile personal computer, an electronic dictionary, a portable video game machine, or a portable navigation system, other than a mobile phone handset. It is also possible to apply the present invention to displays equipped with LCD units such as liquid crystal television sets. In such a case, the present invention can be more effectively applied to a smaller display.

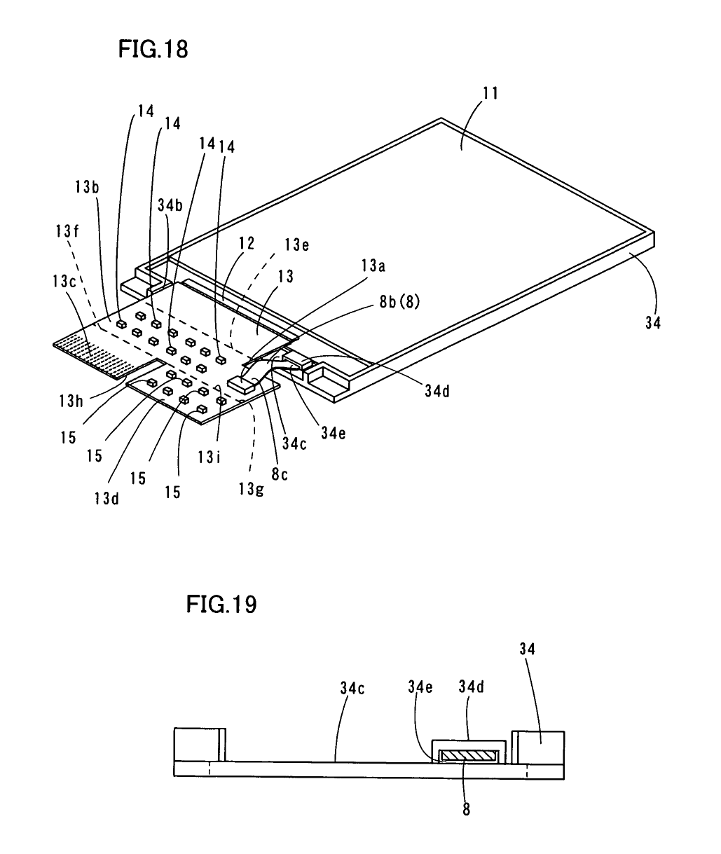

In the above described embodiment, the hook-like portion protruding upward from the upper face of the resin frame is employed, and the backlight FPC board is disposed in the engaging space that is formed by the upper face of the resin frame and the hook-like portion. However, the present invention is not limited to that structure. As shown in a first modification illustrated in FIGS. 18 and 19, a resin frame 34 may have an uplift preventing portion 34d with a hole-like engaging space 34e protruding upward from the upper face 34c of the resin frame 34.

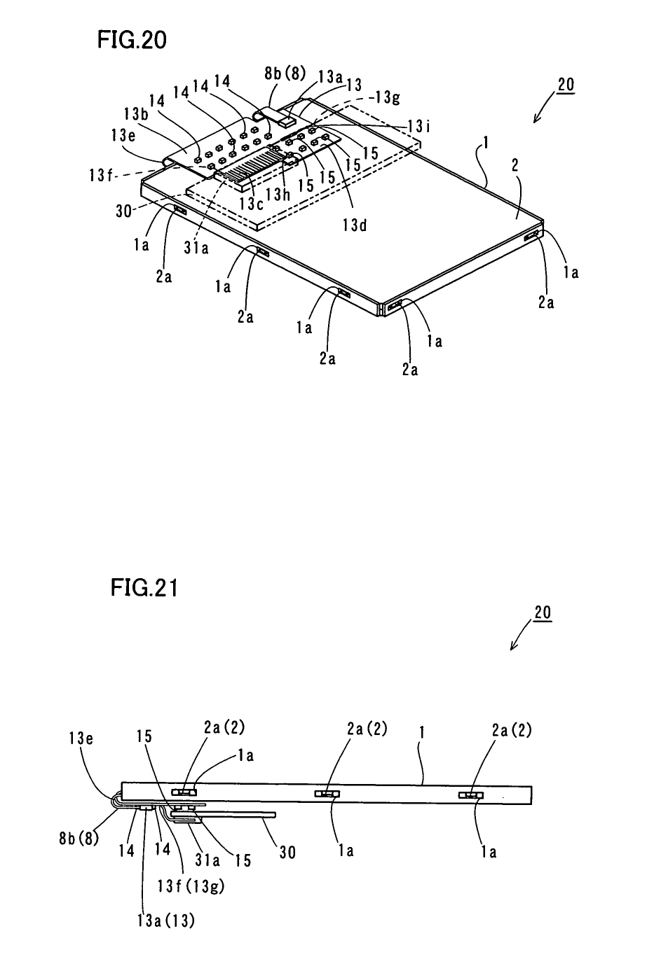

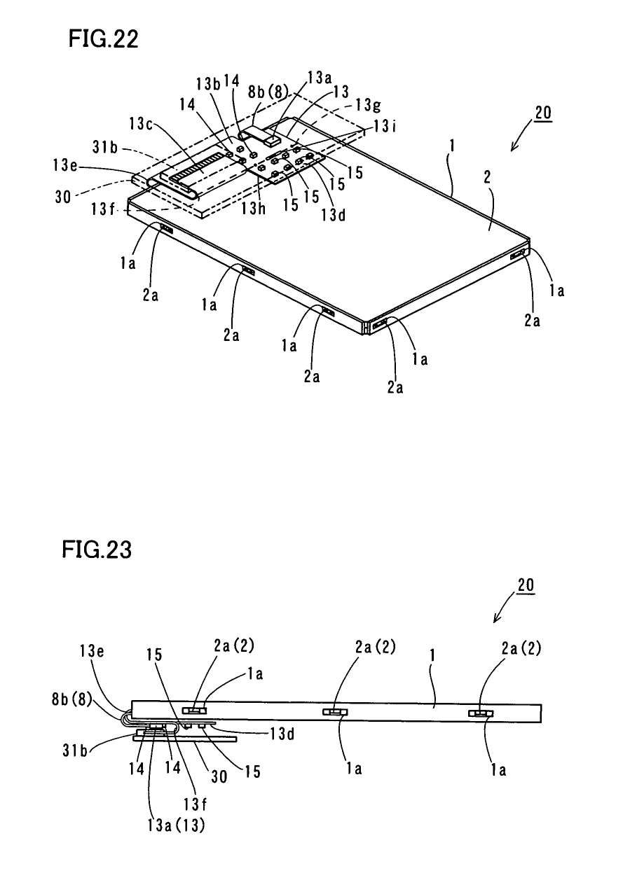

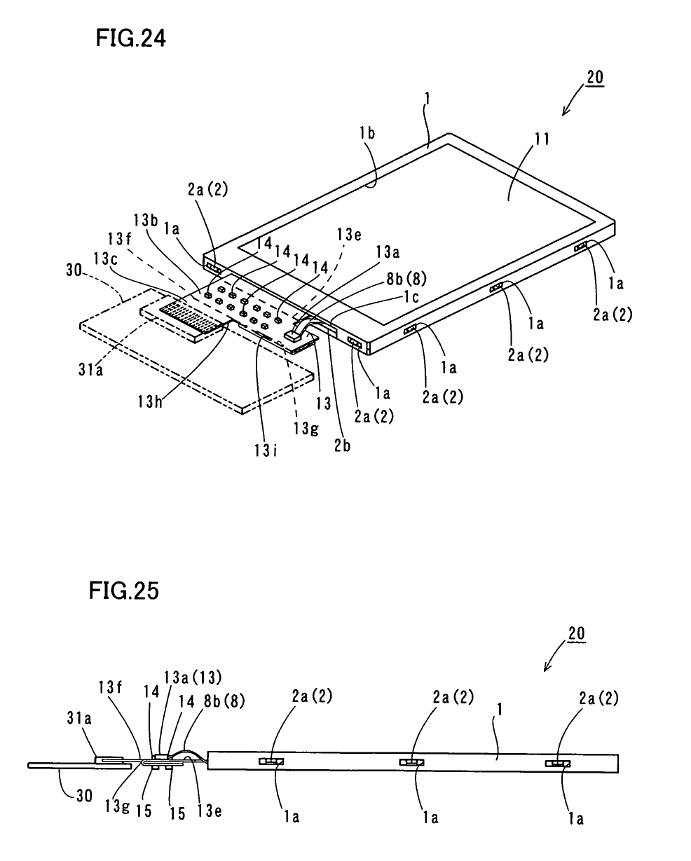

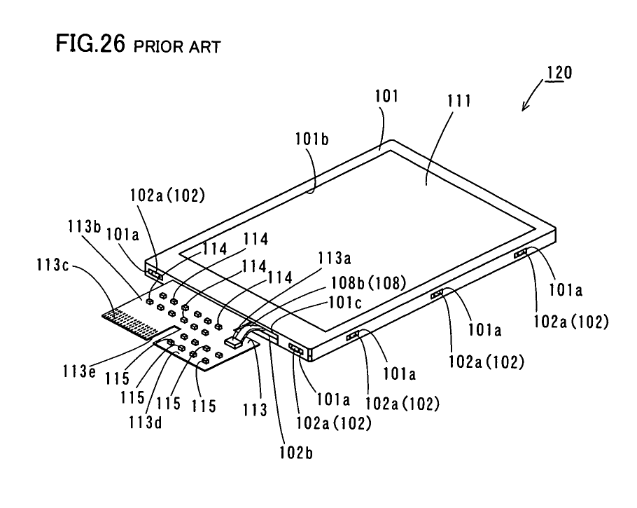

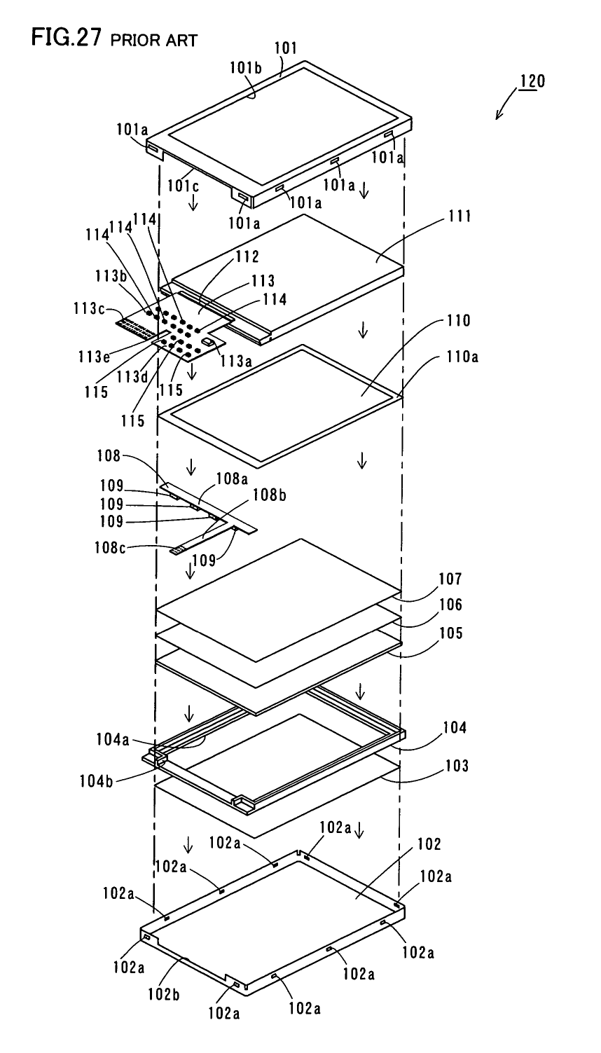

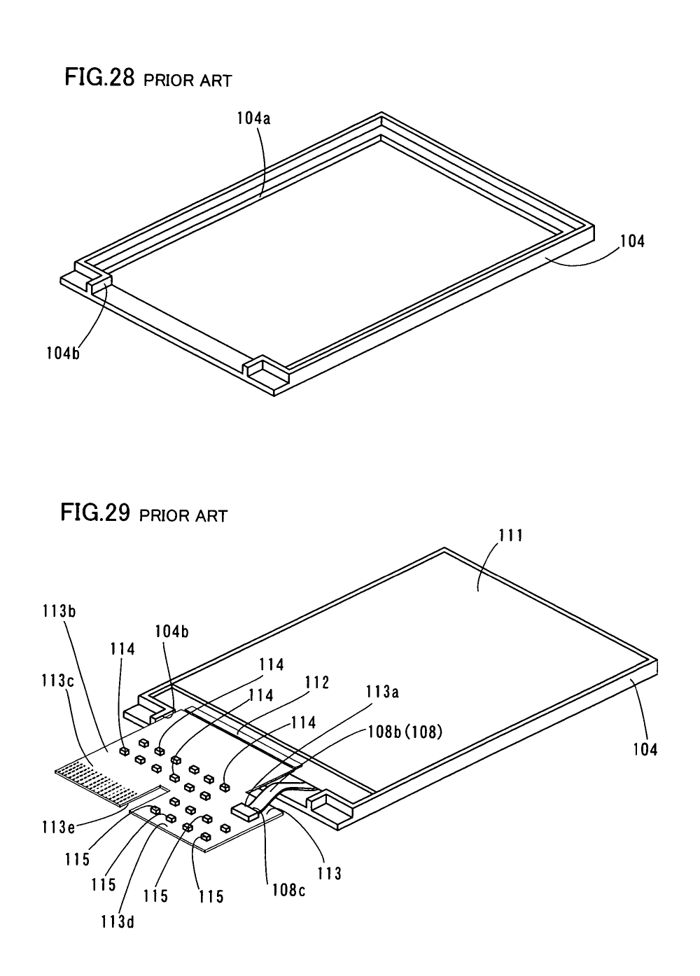

Although the bending portions 13e, 13f, and 13g of the panel FPC board 13 are shown as not being bent in the above embodiment, the present invention is not limited to that structure. FIGS. 20 through 25 illustrate second through fourth modifications of the above embodiment of the present invention. As in the second modification illustrated in FIGS. 20 and 21, the bending portion 13e of the panel FPC board 13 of the LCD unit 20 may be bent, and the connector inserting portion 13c of the panel FPC board 13 extending in the bending direction may be connected to the connector portion 31a of the printed circuit board 30 of a mobile phone handset. In this case, the panel FPC board 13 of the LCD unit 20 may be disposed below the lower frame 2 of the LCD unit 20. As in the third modification illustrated in FIGS. 22 and 23, the bending portions 13e and 13f of the panel FPC board 13 of the LCD unit 20 may be bent, but the bending portion 13g (see FIG. 22) of the panel FPC board 13 may not be bent. In this structure, the panel FPC board 13 can be inserted to a connector portion 31b opposed to the connector portion 31a of the printed circuit board 30 of the mobile phone handset shown in FIGS. 20 and 21. As in the fourth modification illustrated in FIGS. 24 and 25, the bending portions 13e and 13f of the panel FPC board 13 of the LCD unit 20 are not bent, but only the bending portion 13g of the panel FPC board 13 may be bent. In this structure, the electronic components 14 and 15 can be disposed on and below the panel FPC board 13 of the LCD unit 20. Also, as the bending portion 13g of the panel FPC board 13 of the LCD unit 20 is bent, the electronic component attaching portion 13d is disposed below the electronic component attaching portion 13b. Accordingly, the electronic component attaching portion 13d does not overlap the upper portion of the printed circuit board 30 of the mobile phone handset. Thus, the area that can serve as the circuit region of the printed circuit board 30 of the mobile phone handset can be increased.

What is claimed is:

1. A display comprising:
a display panel;
a frame that houses said display panel;
a backlight source that is disposed on the backside of said display panel; and
a first flexible printed circuit board for emitting backlight that is electrically connected to said backlight source, and extends from the inside of said frame to the outside of said frame, wherein
said frame comprises an uplift preventing member that prevents uplift of said first flexible printed circuit board.

2. The display as claimed in claim 1, wherein said uplift preventing member of said frame is engaged with the upper face of said first flexible printed circuit board, so as to restrict the height of said first flexible printed circuit board.

3. The display as claimed in claim 1, wherein said uplift preventing member of said frame is integrally formed with said frame.

4. The display as claimed in claim 1, wherein said uplift preventing member of said frame has a hook-like portion that protrudes upward from the upper face of said frame, with said first flexible printed circuit board being disposed in an engaging space that is defined by the upper face of said frame and said hook-like portion.

5. The display as claimed in claim 4, wherein said engaging space of said uplift preventing member has a vertical length that is larger than the thickness of said first flexible printed circuit board.

6. The display as claimed in claim 4, wherein said engaging space of said uplift preventing member has a horizontal length that is smaller than the width of said first flexible printed circuit board.

7. The display as claimed in claim 4, wherein:
said engaging space of said uplift preventing member is located in the vicinity of an outer edge of said frame, and has an inserting portion that opens in a direction perpendicular to an external connecting portion of said first flexible printed circuit board, said external connecting portion extending from the inside of said frame to the outside of said frame.

8. The display as claimed in claim 1, further comprising
a second flexible printed circuit board for display panels that is attached to said display panel, and extends from the inside of said frame to the outside of said frame, wherein
said second flexible printed circuit board comprises a connector inserting portion, a first bending portion that is formed on the side of said display panel, and a second bending portion that is formed between said connector inserting portion and said first bending portion.

9. The display as claimed in claim 8, further comprising
a first electronic component and a second electronic component that are attached to said second flexible printed circuit board,
said second flexible printed circuit board comprising a first electronic component attaching portion to which said first electronic component is attached, a second electronic component attaching portion to which said second electronic component is attached, and a third bending portion that is formed between said first electronic component attaching portion and said second electronic component attaching portion.

10. The display as claimed in claim 9, wherein said second flexible printed circuit board further comprises a slit that is formed between said connector inserting portion and said second electronic component attaching portion.

11. A mobile device comprising
a display that comprises:
a display panel;
a frame that houses said display panel;
a backlight source that is disposed on the backside of said display panel; and
a first flexible printed circuit board for emitting backlight that is electrically connected to said backlight source, and extends from the inside of said frame to the outside of said frame, wherein
said frame comprises an uplift preventing member that prevents uplift of said first flexible printed circuit board.

12. The mobile device as claimed in claim 11, wherein said uplift preventing member of said frame is engaged with the upper face of said first flexible printed circuit board, so as to restrict the height of said first flexible printed circuit board.

13. The mobile device as claimed in claim 11, wherein said uplift preventing member of said frame is integrally formed with said frame.

14. The mobile device as claimed in claim 11, wherein said uplift preventing member of said frame has a hook-like portion that protrudes upward from the upper face of said frame, with said first flexible printed circuit board being disposed in an engaging space that is defined by the upper face of said frame and said hook-like portion.

15. The mobile device as claimed in claim 14, wherein said engaging space of said uplift preventing member has a vertical length that is larger than the thickness of said first flexible printed circuit board.

16. The mobile device as claimed in claim 14, wherein said engaging space of said uplift preventing member has a horizontal length that is smaller than the width of said first flexible printed circuit board.

17. The mobile device as claimed in claim 14, wherein:
said engaging space of said uplift preventing member is located in the vicinity of an outer edge of said frame, and has an inserting portion that is open in a direction perpendicular to an external connecting portion of said first flexible printed circuit board, said external connecting portion extending from the inside of said frame to the outside of said frame.

18. The mobile device as claimed in claim 11, further comprising
a second flexible printed circuit board for display panels that is attached to said display panel, and extends from the inside of said frame to the outside of said frame, wherein
said second flexible printed circuit board comprises a connector inserting portion, a first bending portion that is formed on the side of said display panel, and a second bending portion that is formed between said connector inserting portion and said first bending portion.

19. The mobile device as claimed in claim 18, further comprising
a first electronic component and a second electronic component that are attached to said second flexible printed circuit board,
said second flexible printed circuit board comprising a first electronic component attaching portion to which said first electronic component is attached, a second electronic component attaching portion to which said second electronic component is attached, and a third bending portion that is formed between said first electronic component attaching portion and said second electronic component attaching portion.

20. The mobile device as claimed in claim 19, wherein said second flexible printed circuit board further comprises a slit that is formed between said connector inserting portion and said second electronic component attaching portion.
